(19) United States
(12) Patent Application Publication
(10) Pub. No.: US 2014/0287120 A1
(43) Pub. Date: Sep. 25, 2014

(54) ORGANIC COMPOUNDS

(71) Applicant: Givaudan S.A, Vernier (CH)

(72) Inventors: Adri De Klerk, Made (NL); Jacob Antonius Elings, Huizen (NL); Cornelis Winkel, Bussum (NL); Alexander P. Tondeur, Loosdrecht (NL)

(73) Assignee: Givaudan S.A., Vernier (CH)

(21) Appl. No.: 14/353,393

(22) PCT Filed: Oct. 26, 2012
(86) PCT No.: PCT/EP2012/071206

§ 371 Date: Apr. 22, 2014

(30) Foreign Application Priority Data
Oct. 26, 2011 (GB) 1118480.1

(51) Int. Cl. A23L 1/228

(52) U.S. Cl. CPC A23L 1/228
USPC 426/534; 426/442; 562/573

(57) ABSTRACT

2-substituted glutamic acid derivative according to the formula (I) or its physiologically acceptable salts

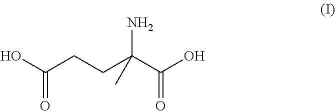

are useful to impart, enhance or modify umami-and/or salt taste in a comestible product.

This invention relates to the use of a compound that can create, modify or enhance umami- and/or salt-tastes in comestible products.

Umami and salt taste are important flavour sensations that are particularly associated with Asian cuisine. Furthermore, the two tastes are somewhat complementary in that improving umami taste can help reduce salt content and make low salt products taste more palatable.

Principal amongst umami tastants is monosodium glutamate (MSG). However, even though MSG is considered safe by health authorities and that there are no adverse clinical studies associated with its use, it remains a controversial additive based on the perception that there are health issues associated with it.

There remains a need for alternative compounds to impart, enhance or modify umami- or salt-taste to food products.

Surprisingly, despite the excellent umami taste of MSG, there is very little mention in the literature of the use of glutamic acid derivatives in food products to impart, enhance or modify umami and/or salt taste.

Of course, the skilled person will appreciate that the sensation of taste is a highly subjective matter. There appears to be little or no correlation between a compound's chemical structure and it having the attribute of imparting a desirable umami taste. At the biological level, the umami and sweet receptors are structurally and functionally very closely related As such, a compound that might be a substrate for the umami receptor, might also be a substrate for, or interact with, the sweet receptor. This might explain why one compound might be considered to have a highly desirable umami taste, whereas a structurally similar compound may have a completely undesirable character.

The sensitivity of chemical structure and the perception of taste is well known. MSG, as we know, is a highly potent umami tastant. Yet, the structurally related compound aspartic acid (one methylene radical removed from MSG) has hardly any umami taste at comparable concentrations.

The biology of salt sensation is an equally complex matter, making prediction of salt taste based on structure very unreliable. Salt taste is uniquely provided by sodium chloride (NaCl). All other salts lack at least some of the typical positive taste attributes of sodium chloride. Potassium chloride tastes somewhat salty but clearly more bitter. Sodium acetate or sodium gluconate have hardly any taste. Lead chloride is even tasting sweet.

There remains a need to provide compounds that are useful for imparting, modifying or enhancing an umami- and/or salt-taste to a comestible product.

In a first aspect of the present invention there is provided the use of a 1-substituted glutamic acid of formula (I) in a method of imparting, enhancing or modifying an umami- and/or salt-taste in a comestible product

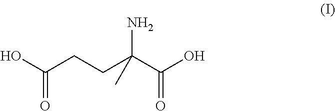

The compound of formula I may be used in the form as shown above, or in its ionic form with or without a counter-ion (in form of its salt), for example its sodium, potassium, calcium, ammonium, chloride, sulphate, phosphate, carbonate salt, or similar physiologically acceptable counter-ion. Furthermore, the compound of formula (I) contains a chiral carbon atoms and can be employed in the present invention as a racemic mixture or in a resolved and isomerically pure form.

The compound of formula (I) may be used as the sole ingredient in a method of imparting, enhancing or modifying an umami and/salt taste in a comestible product, or they may be used as part of a flavour composition containing one or more additional flavour ingredients.

Accordingly, in another aspect, the invention is directed to a flavour composition comprising the compound of formula I as defined hereinabove.

The one or more said additional flavour ingredients may be selected from natural flavours, artificial flavours, spices, seasonings, and the like, synthetic flavour oils and flavouring aromatics and/or oils, oleoresins, essences, distillates, and extracts derived from plants, leaves, flowers, fruits, and so forth, Generally, any flavouring or food additive such as those described in Chemicals Used in Food Processing, publication 1274, pages 63-258, by the National Academy of Sciences, can be used. This publication is incorporated herein by reference.

Particular examples of other umami compounds that may be employed as additional flavour ingredients include the compounds described in UK patent application No. 0913804 and International Application No. PCT/EP2010/059916. Other non-limiting examples of umami flavour-conferring and -enhancing compounds include those described in EP 1642886, WO 2005/015158, EP 1312268, WO 2003/088768, EP 1291342 and WO 2006/003107, all of which references are incorporated herein by reference.

The compound of the formula (I) may be employed as the sole flavour ingredient in a flavour composition or may form only a part of the flavour ingredients. In a particular embodiment it may be employed in amounts of about 0.001 to 100% of said flavour composition.

The compound of formula (I) may be used in reduced salt/MSG flavour compositions, or in salt-/MSG-free flavour compositions, as well as those flavour compositions that contain salt/MSG in customary amounts. It is customary to employ MSG in such amounts such that when a flavour composition is added to a comestible product, the MSG is present in amounts of between about 200 to 500 ppm. In reduced MSG comestible products, the amount of MSG is usually a lower amount in the range of about 100 to 200 ppm.

It is customary to employ salt (that is, sodium chloride) in such amounts such that when a flavour composition is added to a comestible product, the sodium chloride may be present in amounts of between about 0.8 and 2%. In reduced sodium chloride comestible products, the amount of sodium chloride is usually a lower amount in the range of about 0.4 to 0.8%.

The proportions of MSG, salt and compound of formula (I), as well as any other flavour ingredients that might be desired will naturally depend on the desired flavour profile for any given formulation and the skilled person can easily determine the relevant proportions for any case by means of routine, non-inventive experimentation.

In another aspect, the invention is directed to a method of imparting saltiness to a comestible product, or enhancing or modifying the saltiness of a comestible product comprising the addition to said product, a compound of formula (I) or a flavour composition containing same, said comestible product containing salt (NaCl) in an amount of at least 0.3%.

In another aspect, the invention is directed to a method of imparting umami taste to a comestible product, or enhancing or modifying the umami taste of a comestible product comprising the addition to said product, a compound of formula (I) or a flavour composition containing same, said comestible product containing MSG in an amount of at least 50 ppm.

In a method of imparting, enhancing or modifying the umami and/or salt taste of a comestible product, an appropriate concentration in which to employ compounds of formula (I) will depend on the type of comestible product and the desired flavour intensity. For example, the compound according to formula (I) may be employed at a concentration of, for example, 1 to 25.000 ppm, more particularly 1 to 1000 ppm, still more particularly 5 to 100 ppm, based on weight.

The term “comestible product(s)” refers to any composition that is consumed for at least one of nourishment and pleasure, or that is placed in the mouth to achieve an effect before being discarded.

The comestible product may be in any physical form. Examples of comestible products wherein compounds according to the invention may be incorporated included by way of example the Wet Soup Category, the Dehydrated and Culinary Food Category, the Beverage Category, the Frozen Food Category, the Snack Food Category, and seasonings or seasoning blends. “Wet Soup Category” means wet/liquid soups regardless of concentration or container, including frozen Soups. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

“Dehydrated and Culinary Food Category” means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

“Beverage Category” means beverages, beverage mixes and concentrates, including but not limited to, alcoholic and non-alcoholic ready to drink and dry powdered beverages. Other examples of foods and beverages wherein compounds according to the invention may be incorporated included by way of example carbonated and non-carbonated beverages, e.g., sodas, fruit or vegetable juices, alcoholic and non-alcoholic beverages, confectionary products, e.g., cakes, cookies, pies, candies, chewing gums, gelatins, ice creams, sorbets, puddings, jams, jellies, salad dressings, and other condiments, cereal, and other breakfast foods, canned fruits and fruit sauces and the like.

A person skilled in the art will appreciate that flavour formulations and comestible products of the present invention may contain additional ingredients, which may comprise various additives and excipients well known in the art, including anti-caking agents, anti-foaming agents, anti-oxidants, binders, colourants, diluents, disintegrants, emulsifiers, encapsulating agents or formulations, enzymes, fats, flavour-enhancers, flavouring agents, gums, lubricants, polysaccharides, preservatives, proteins, solubilisers, solvents, stabilisers, sugar-derivatives, surfactants, sweetening agents, vitamins, waxes, and the like. Solvents which may be used are known to those skilled in the art and include e.g. ethanol, ethylene glycol, propylene glycol, glycerine and triacetin,. Encapsulants and gums include maltodextrin, gum arabic, alginates, gelatine, modified starch, and polysaccharides. Examples of additives, excipients, carriers, diluents or solvents for flavour or fragrance compounds may be found e.g. in “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

Any of the compounds of the present invention, additional flavour ingredients or any of the ingredients, additives or excipients may be formulated in an appropriate vehicle, e.g. they may be in encapsulated form, or bound in a matrix or the like, in order to achieve a desired technical effect such as to achieve stability or to effect controlled release.

There now follows a series of non-limiting examples that serve to illustrate the invention.

### EXAMPLE 1

### DL-2-Methylglutamic Acid

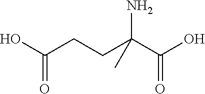

Purchased from Acros, product number 16497

### EXAMPLE 2

Two solutions were prepared:

A a solution of 0.5% NaCl and 0.03% MSG

B a solution of 0.5% NaCl and 0.03% MSG and 10 ppm Example 1 compound

The samples were tasted by a small group of flavourists (2 male, 2 female, aged between 30 and 60). The intensity of the umami and salt taste of solution B was compared with that of the reference (solution A) and rated according to the following intensity scale:

Taste effect much lower than base: −3

Taste effect lower than base: −2

Taste effect slightly lower than base: −1

Taste effect same as base: 0

Taste effect slightly higher than base: 1

Taste effect higher than base: 2

Taste effect much higher than base: 3

The results (average of rating given by the flavourists) were:

Intensity Taste

| Sample | Umami | Salt (NaCl) |
|---|---|---|
| solution A (reference) | 0.00 | 0.00 |
| DL-2-methylglutamic acid | 0.00 | 1.00 |

### EXAMPLE 3

A bread flour mixture was prepared by mixing 1250 g of wheat flour, 250 g of white wheat flour and 60 g of yeast. Two salt mixtures were added to separate flour mixtures:

A 20 g of NaCl

B 20 g of NaCl and 0.025 g DL-2-methylglutamic acid

Doughs were prepared by mixing the ingredients and adding 900 g of water. The doughs were allowed to rise at room temperature for 2 hours and baked at 220° C. for 45 minutes.

A panel of professional tasters compared the breads. The bread B was preferred over reference bread A.

1. A process comprising utilizing a 2-substituted glutamic acid of formula (I) or its physiologically acceptable salts to impart, enhance or modify an umami- and/or salt-taste in a comestible product

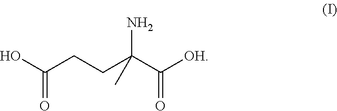

2. A flavour composition comprising a compound of formula (I) or its physiologically acceptable salts.

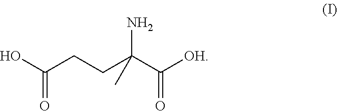

3. The flavour composition according to claim 2 comprising the compound of formula (I) or its physiologically acceptable salts in an amount of from 0.001 to 100% by weight.

4. The flavour composition according to claim 2 comprising MSG or salt.

5. The flavour composition according to claim 4 wherein the MSG is present in amounts of about 200 to 500 ppm.

6. The flavour composition according to claim 4 wherein the MSG is present in amounts of about 100 to 200 ppm.

7. The flavour composition according to claim 4 wherein the salt is present in amounts of about 0.8% to 2%.

8. The flavour composition according to claim 4 wherein the salt is present in amounts of about 0.4% to 0.8%.

9. A comestible product containing the flavour composition as defined in claim 2.

10. The comestible product according to claim 9 wherein the flavour composition comprises the compound of formula (I) or its physiologically acceptable salts in an amount of from 0.001 to 100% by weight.

11. The comestible product according to claim 9 wherein the flavour composition comprises MSG or salt.

12. The comestible product according to claim 11 wherein the MSG is present in amounts of about 200 to 500 ppm in the flavour composition.

13. The comestible product according to claim 11 wherein the MSG is present in amounts of about 100 to 200 ppm in the flavour composition.

14. The comestible product according to claim 11 wherein the salt is present in amounts of about 0.8% to 2% in the flavour composition.

15. The comestible product according to claim 11 wherein the salt is present in amounts of about 0.4% to 0.8% in the flavour composition.
